(19) United States
(12) Patent Application Publication
(10) Pub. No.: US 2004/0126046 A1
(43) Pub. Date: Jul. 1, 2004

(54) Threaded type bearing assembly

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,465

(22) Filed: Dec. 31, 2002

(51) Int. Cl. F16C 43/00; F16C 13/00

(52) U.S. Cl. 384/545; 384/540

(57) ABSTRACT

A bearing assembly for bicycle connected to one of two ends of the head tube includes a first race having a skirt portion and a groove defined in an inner periphery of the skirt portion so as to receive beads therein. A second race is engaged with the skirt portion and positions the beads in the groove. An insertion extends from the first race and includes threads defined in an outer periphery thereof. The head tube has two inner threaded sections defined in an inner periphery in two open ends thereof and the insertion is threadedly engaged with one of the inner threaded sections of the head tube.

### FIELD OF THE INVENTION

The present invention relates to a threaded bearing assembly for bicycles and includes a race that has a threaded insertion so as to be threadedly connected to the head tube.

### BACKGROUND OF THE INVENTION

A conventional bearing assembly for bicycle and generally includes an upper race, a lower race and a bearing set which is engaged between the upper race and the lower race. The bearing assembly is mounted to the head tube and the steerer tube extends through the bearing assembly so that when turning the handlebar, the steerer tube is smoothly rotated relative to the head tube such that the front wheel of the bicycle turns. In the processes of assembling the bearing assembly to the head tube, the upper race or the lower race has to be forced to fit with the head tube by machine which exerts a force to firmly connect the upper race or the lower race to the head tube. Nevertheless, during the pressing procedure, the upper race or the lower race might not be positioned as precise as desired relative to the head tube so that there could be a small angle difference when cooperated with the other race. This definitely affects the installation of the bearing set and accelerates worn of the parts. Besides, when the bearing assembly requires maintenance, the upper race and the lower race is difficult to be separated and the force to separate the two races could damage the contour of the races.

The present invention intends to provide a bearing assembly wherein the races are simply threadedly connected to the head tube so as to solve the potential problems found in the conventional bearing assemblies.

### SUMMARY OF THE INVENTION

In accordance with one aspect of the present invention, there is provided a combination of head tube and two bearing assemblies. The two bearing assemblies are respectively connected to two ends of the head tube which has two inner threaded sections defined in an inner periphery in two open ends of the head tube. Each of the two bearing assemblies comprises a first race having a skirt portion and a plurality of beads are received in a groove in the skirt portion.

An insertion extends from the first race and includes threads defined in an outer periphery thereof. The insertion is threadedly engaged with one of the inner threaded sections of the head tube. A second race is engaged with the skirt portion and positions the beads in the groove.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows two bearing assemblies of the present invention and the head tube to be connected with the two bearing assemblies;

FIG. 2 is an exploded view to show the two bearing assemblies of the present invention;

FIG. 3 shows a cross sectional view of the connection of the bearing assemblies of the present invention and the head tube;

FIG. 4 shows an enlarged view of the connection of a bearing assembly of the present invention and the head tube;

FIG. 5 shows that the threads of the insertions of the two bearing assemblies of the present invention and the head tube are fine threads, and

FIG. 6 shows an enlarged view of the connection of a bearing assembly of the present invention and the head tube as disclosed in FIG. 5.

### DETAILED DESCRIPTION OF THE PREFERRED EMBODIMENT

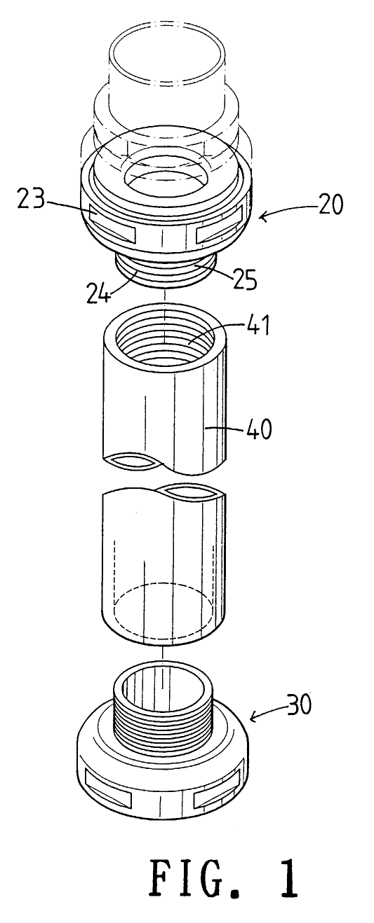

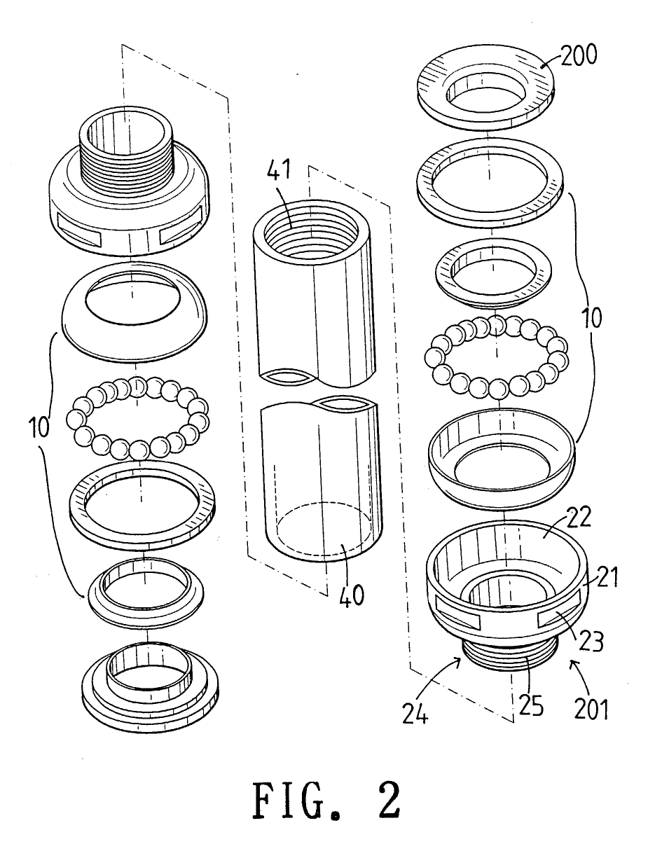

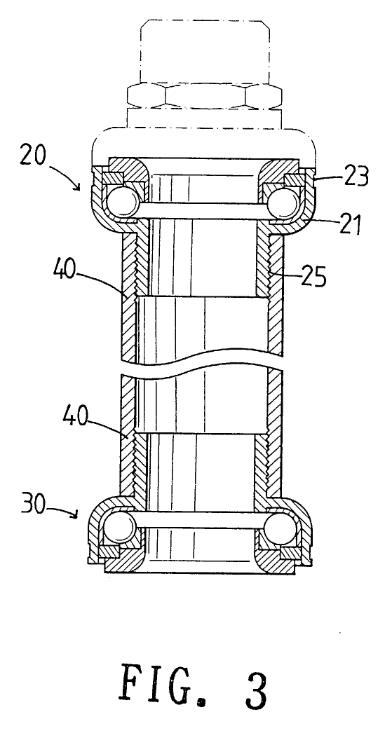

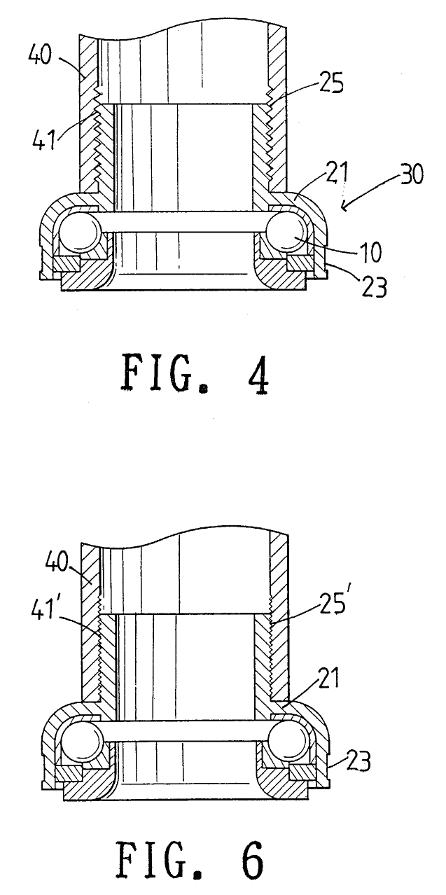

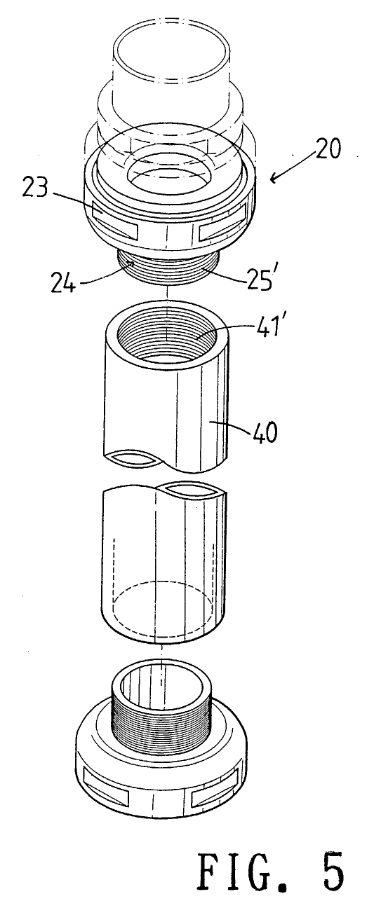

Referring to FIGS. 1 to 4, the bearing assemblies 20 and 30 are respectively connected to two ends of the head tube 40 and a steerer tube (not shown) extends through the passage in the head tube 40 and the two bearing assemblies 20 and 30 are mounted to the steerer tube. A handlebar (not shown) is connected to the steerer tube.

The head tube 40 has two inner threaded sections 41 defined in an inner periphery in two open ends thereof. Each of the two bearing assemblies 20 and 30 comprises a first race 201 which has a skirt portion 21 and a groove 22 is defined in an inner periphery of the skirt portion 21. An insertion 24 extends from a first side of the first race 201 and includes threads 25 defined in an outer periphery thereof. The insertion 24 is threadedly engaged with one of the inner threaded sections 41 of the head tube 40. A plurality of beads and positioning rings 10 are received in the groove 22 and a second race 200 is engaged with the skirt portion 21 so as to position the beads and the positioning rings 10 in the groove 22.

The skirt portion 21 of the first race 201 of each of the two bearing assemblies 20 and 30 includes at least two recesses 23 defined in an outer periphery thereof. Therefore, the user may clamp the skirt portion 21 by engaging a wrench or a proper tool with the at least two recesses 23 to rotate the first race 201.

By the bearing assembly of the present invention, the assemblers just simply use wrench to install the bearing assemblies without too much skill required and the bearing assemblies are expected to be installed precisely.

FIGS. 6 and 7 show that the inner threaded sections 41 and the threads 25 can be made to be fine threads so as to more firmly connect the bearing assemblies 20 and 30 with the head tube 40.

While we have shown and described the embodiment in accordance with the present invention, it should be clear to those skilled in the art that further embodiments may be made without departing from the scope of the present invention.

What is claimed is:

1. A combination of head tube and two bearing assemblies, the two bearing assemblies respectively connected to two ends of the head tube, the head tube having a passage defined therethrough and two inner threaded sections defined in an inner periphery in two open ends of the head tube;
each of the two bearing assemblies comprising a first race having a skirt portion and a groove defined in an inner periphery of the skirt portion, an insertion extending from the first race and including threads defined in an outer periphery thereof, the insertion threadedly engaged with one of the inner threaded sections of the head tube, a plurality of beads received in the groove, and
a second race engaged with the skirt portion and positioning the beads in the groove.

2. The combination as claimed in claim 1, wherein the skirt portion of the first race of each of the two bearing assemblies includes at least two recesses defined in an outer periphery thereof.
